(19) United States
(12) Patent Application Publication
(10) Pub. No.: US 2007/0171167 A1
(43) Pub. Date: Jul. 26, 2007

(54) GAMMA CURVE COMPENSATING DEVICE AND METHOD USING THE SAME

(76) Inventor: Wei-Hsiang Shen, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(21) Appl. No.: 11/309,073

(22) Filed: Jun. 16, 2006

(30) Foreign Application Priority Data
Jan. 10, 2006 (TW) 95100866

(51) Int. Cl. G09G 3/36

(52) U.S. Cl. 345/89

(57) ABSTRACT

The present invention provides a gamma curve compensating device and method using the same. The gamma curve compensating device includes an amplifier module, a signal corrector, and an attenuating unit. The amplifier module receives and amplifies a signal, and couples to a first impedance element and a second impedance element. The signal corrector includes a third impedance element which serially connects to a first transistor and couples to the amplifier module. When the voltage difference between an output terminal of the amplifier module and a control terminal of the first transistor is larger than a startup voltage of the first transistor, the signal corrector changes the signal output by the amplifier module and generates a compensated video signal. The attenuating unit connects with the output terminal of the amplifier module to attenuate the signal at the output terminal of the amplifier module, thereby outputting the gamma compensated video signal.

### CROSS-REFERENCE TO RELATED APPLICATION

This application claims the priority benefit of Taiwan application serial no. 95100866, filed on Jan. 10, 2006. All disclosure of the Taiwan application is incorporated herein by reference.

### BACKGROUND OF THE INVENTION

1. Field of Invention

The present invention relates to a compensating device and a method thereof, and more particularly, to a gamma curve compensating device and a method using the same.

2. Description of Related Art

In a conventional liquid crystal display device, a voltage corresponding to a video signal is applied to a pixel by means of nonlinearity, so as to cater to the situation that human vision reacts differently to different levels of brightness. A nonlinear voltage can be used to display various levels of brightness suitable for the reaction of human vision on a screen, such that the display effects will be improved efficiently.

FIG. 1 is a voltage diagram of a gamma curve for a conventional liquid crystal display (LCD). The horizontal axis represents a normalized input voltage, and the vertical axis represents a normalized output voltage. For convenience of illustration, the highest normalized voltage value is set to 1. The corresponding equation of the gamma curve is as follows: normalized output voltage=normalized input voltagê gamma. The equation indicates that the normalized output voltage is the normalized input voltage powered by the gamma. The gamma adjusting curve 101 is a straight line with the gamma being set to 1, and at this time, the normalized input voltage is equal to the normalized output voltage. However, since it is difficult for human vision to recognize layers with regard to the part with a high brightness, the layer sense of a frame should be displayed with a lower brightness. The gamma curve 102 is a curve with the gamma equal to 2.2, which is the value of gamma often used by a common LCD to make the input voltage correspond to the lower output voltage so as to increase the levels of the frame, thereby promoting the stereo sensation. Furthermore, in a cathode ray tube (CRT), a preferable frame is displayed by adjusting a gamma. Generally speaking, the gamma of CRT is 2.5. Therefore, from the perspective of chromatology, most preferable display effects can be achieved in various displays by setting specific values of gamma.

The gammas of various displays are different along with their different materials, constructions, etc. Even for displays with the same specifications, the setting of gamma will be influenced due to slight changes in the manufacturing processes. In the conventional gamma adjusting method, an integrated circuit or software is used to adjust gamma, wherein the construction of the integrated circuit is complicated. If software is used to adjust gamma, it must be controlled through an operating system (OS), thereby reducing compatibility.

ROC Patent No. 00503385 discloses a grayscale display reference voltage generation circuit capable of changing gamma correction characteristics and a liquid crystal display driving unit using the same for generating a reference voltage for the grayscale display to switch the display data from digital form into analog form. FIG. 2 is a circuit diagram of a grayscale display reference voltage generation circuit 21. Gamma adjusting data is input into the grayscale display reference voltage generation circuit 21, and a data latching circuit 23 is used to latch the adjustment data when fine adjusting the gamma. A gamma correction and adjustment circuit 22 corrects an output reference voltage value according to the adjustment data, wherein the voltage V0 and voltage V 64 are divided via the resistors R20-R27 so as to provide different voltages to the gamma correction and adjustment circuit 22. The gamma correction and adjustment circuit 22 is used to adjust received voltage upwards or downwards according to control data, and the voltage is equally divided into 8 parts via eight resistors (not shown), so as to be output.

FIG. 3 is a circuit diagram of the gamma correction and adjustment circuit 22. A voltage is input via an input terminal 37 to the gamma correction and adjustment circuit 22 and output via an output terminal 38. Current sources i, 2i, 4i, 8i, and 16i are individually selected to be ON/OFF through switches SW3_1-SW3_20 according to the adjustment data, so as to supply the current for a resistor R 31 with different combinations thereof. As a result, a voltage difference is generated across both ends of the resistor R 31, and the voltage of the output terminal 38 can be adjusted upward or downward through the voltage difference. The conventional art is only suitable for a liquid crystal display and the corrected signal is a digital video signal, and an analog video signal cannot be corrected. Furthermore, in the conventional art, the grayscale reference voltage is changed by adjusting a current, resulting in a much more complicated circuit.

### SUMMARY OF THE INVENTION

The present invention provides a gamma curve compensating device for carrying out a gamma curve compensation for a video signal, thereby changing a corresponding grayscale effect to improve display quality. Meanwhile, the gamma curve compensating device has the advantages of lower circuit complexity and the ability to obtain different output gammas through adjustment.

The present invention further provides a gamma curve compensating method with the advantages of lower circuit complexity and the ability to obtain different output gammas through adjustment. Through the method, a gamma curve compensation is carried out for a video signal to change a corresponding grayscale effect to improve display quality.

The gamma curve compensating device provided by the present invention comprises a first impedance element, a second impedance element, an amplifier module, a signal corrector, and an attenuating unit. The amplifier module respectively couples to the first impedance element and the second impedance element through two ends for receiving a video signal and outputting and amplifying the signal. The signal corrector comprises a third impedance element and a transistor. When the voltage difference between the amplifier module and a control terminal of the first transistor is larger than a startup voltage of the first transistor, the signal corrector changes the output signal of the amplifier module and generates a compensated video signal. The attenuating unit attenuates the output signal of the amplifier module and outputs the gamma compensated video signal.

The present invention further provides another gamma curve compensating method which comprises the following steps. Firstly, a first impedance element is configured and electrically coupled to the second impedance element through the amplifier module. Then, a signal corrector with a third impedance element and a first transistor is configured, wherein one end of the first impedance element is coupled to the amplifier module and the second impedance element. After that, the amplifier module receives the video signal to generate an amplified signal. Then, the signal corrector receives the amplified signal, and when the voltage difference between the voltage of the amplified signal and that of the control terminal of the first transistor is larger than a startup voltage of the first transistor, the signal corrector corrects and changes the amplified signal and generates a compensated video signal according to an impedance ratio obtained by comparing the impedance of the first impedance element with that obtained after combining the second and third impedance elements.

According to one preferred embodiment of the present invention, the gamma curve compensating method further comprises configuring an attenuating unit, wherein the attenuating unit is coupled to the coupling point between the third impedance element and the amplifier module to attenuate the signal at the coupling point between the third impedance element and the amplifier module of the signal corrector, so as to output the gamma compensated video signal.

Different transistors are employed in the present invention to generate different gain values to compensate the gamma curve structure, which has the advantages of lower circuit complexity and the ability to obtain different output gammas through adjustment, thereby carrying out a gamma curve compensation for a video signal, changing the corresponding grayscale effect, and improving display quality.

In order to make the aforementioned and other objects, features, and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a gamma curve voltage diagram of a conventional liquid crystal display (LCD).

FIG. 2 is a circuit diagram of a conventional grayscale display reference voltage generation circuit 21.

FIG. 3 is a circuit diagram of a conventional gamma correction and adjustment circuit 22.

FIG. 4 is a circuit diagram of a gamma curve compensating device according to one embodiment of the present invention.

FIG. 5A is a voltage-to-time diagram of an input video signal according to one embodiment of the present invention.

FIG. 5B is a voltage-to-time diagram of the video signal output by a signal output/input terminal B1 through the amplifier module 401 according to one embodiment of the present invention.

FIG. 5C is a voltage-to-time diagram of the video signal before compensated by the signal corrector 402 according to one embodiment of the present invention.

FIG. 5D is a voltage-to-time diagram of the video signal after compensated by the signal corrector 402 according to one embodiment of the present invention.

FIG. 5E is a voltage-to-time diagram of the compensated video signal output by the attenuating unit 403 and the follower impedance matching element 404 according to one embodiment of the present invention.

FIG. 6A is a voltage-to-time measuring diagram of the video signal before compensated by the gamma curve compensating device according to one embodiment of the present invention.

FIG. 6B is a voltage-to-time measuring diagram of the video signal after compensated by the gamma curve compensating device according to one embodiment of the present invention.

FIG. 7 is a flow chart of a gamma curve compensating method according to one embodiment of the present invention.

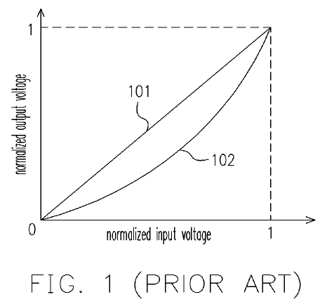

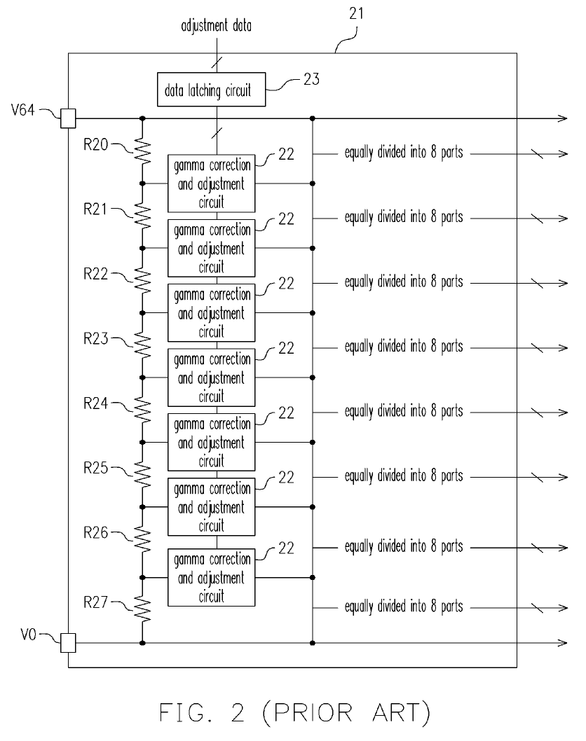

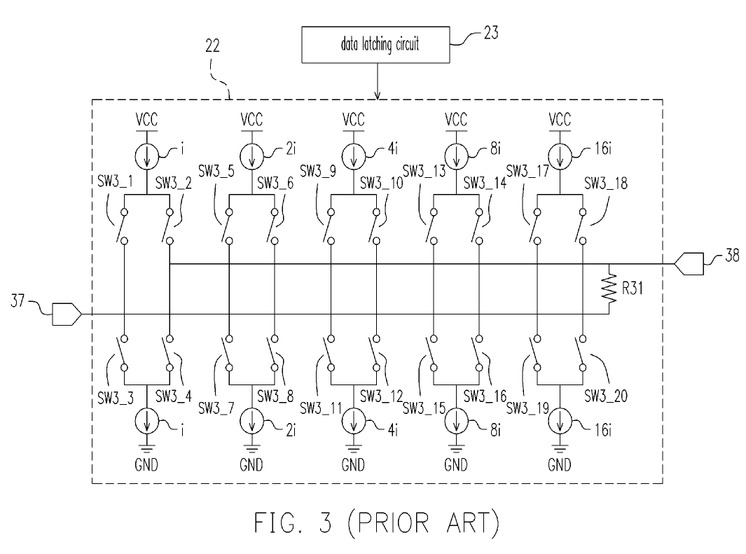

### DESCRIPTION OF EMBODIMENTS

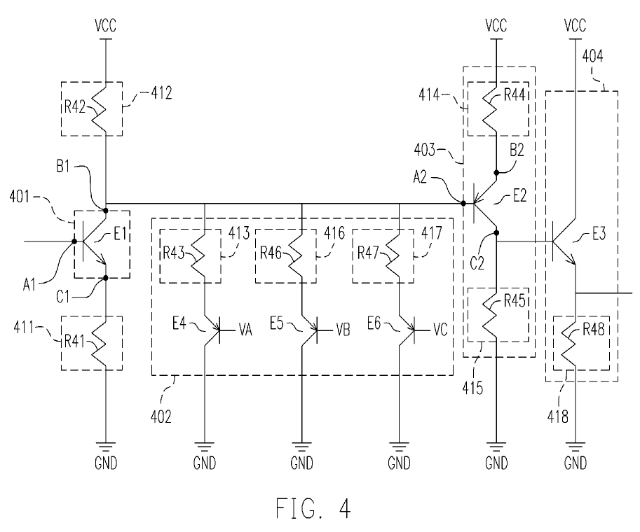

FIG. 4 is a circuit diagram of a gamma curve compensating device according to one embodiment of the present invention. The gamma curve compensating device comprises an impedance element 411, an impedance element 412, an amplifier module 401, a signal corrector 402, an attenuating unit 403, and a follower impedance matching element 404, wherein the impedance elements 411 and 412 are implemented by resistors R41 and R42. The amplifier module 401 receives and amplifies a signal, and outputs the amplified signal via the terminal connected with the resistor R42. The amplifier module 401 comprises a transistor E1 with a control terminal A1 and signal input/output terminals B1 and C1, wherein the control terminal A1 is used to receive the video signal. One end of the resistor R41 is electrically coupled to a ground voltage GND, and the other end is coupled to the signal input/output terminal C1 of the transistor E1. One end of the resistor R42 is electrically coupled to a predetermined voltage VCC, and the other end is electrically connected to the signal input/output terminal B1 of the transistor E1, where the amplified signal is output.

The signal corrector 402 comprises impedance elements 413, 416, and 417 and transistors E4, E5, and E6, wherein the impedance elements 413, 416, and 417 are implemented by resistors R43, R46, and R47. One end of each of the resistors R43, R46, and R47 is coupled to the signal input/output terminal B1 of the transistor E1, and the other end of each of the resistors R43, R46, and R47 is respectively connected to the transistors E4, E5, and E6 in series. When the voltage difference between the voltage of the signal input/output terminal B1 of the transistor E1 and that of the transistor E4 is larger than a startup voltage of the transistor E4, the signal corrector 402 receives the amplified signal to change the output video signal of the transistor E1, and generates a compensated video signal through the resistor R43. The video signal compensation of the transistors E5 and E6 can be carried out in the similar way. The transistors E4, E5, and E6 of the signal corrector are respectively controlled by different voltages VA, VB, and VC. According to the voltage of the video signal, the transistors E4-E6 are combined with the resistors R41, R42, R43, R46, and R47 to provide compensation methods with different voltage change slopes. Those skilled in the art should know that the number of transistors for the signal corrector is not limited to 3, and can be adjusted to 1, 2, or more than 3 depending on requirements, so as to provide compensation methods with different voltage changes combined with different impedance elements, thereby achieving the most preferable video signal compensation effects.

The attenuating unit 403 is connected to the signal input/output terminal B1 of the transistor E1 to output an attenuated gamma compensated video signal. The attenuating unit 403 comprises a transistor E2, impedance elements 414 and 415, wherein the impedance elements 414 and 415 are implemented by resistors R44 and R45. The transistor E2 has a control terminal A2, signal input/output terminals B2 and C2. One end of the resistor R44 is electrically coupled to a predetermined voltage VCC, and the other end is connected to the signal input/output terminal B2 of the transistor E2. One end of the resistor R45 is electrically coupled to a ground voltage GND, and the other end is electrically coupled to the signal input/output terminal C2 of the transistor E2, so as to output the attenuated gamma compensated video. The follower impedance matching element 404 comprises a transistor E3 and an impedance element 418, wherein the impedance element 418 is implemented by a resistor R48. The follower impedance matching element 404 is used to receive the gamma compensated video signal and to match the output impedance. The other end of the follower impedance matching element 404 is connected to the predetermined voltage VCC. It can be seen from the embodiments that the circuit is less complicated and can be easily adjusted; and the signal corrector 402 are not limited to transistors E4-E6 but have high expansion, so as to achieve the most preferable effect when processing an analog video signal.

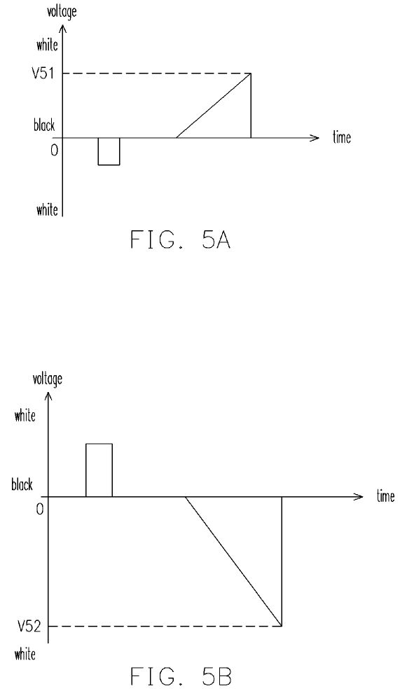

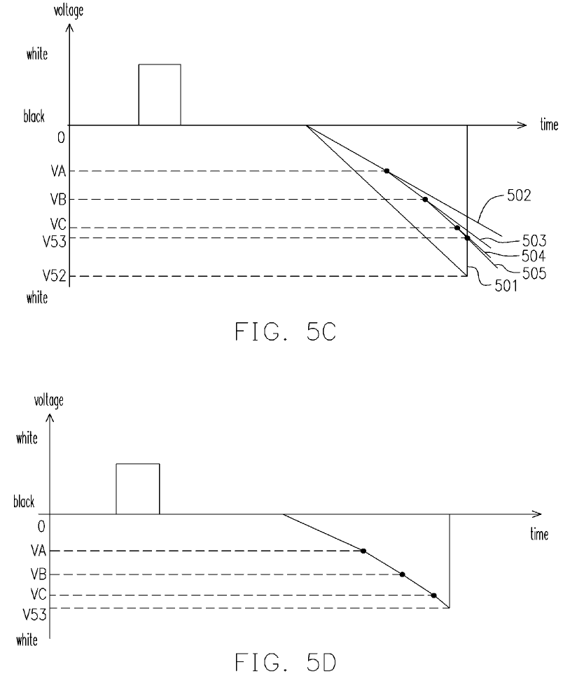

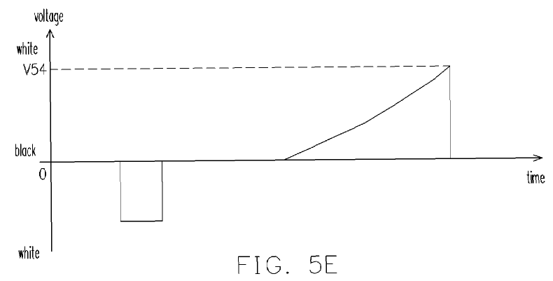

FIGS. 5A-5E are voltage-to-time diagrams of the gamma curve video compensation according to the embodiments of the present invention. Referring to FIG. 4 and FIGS. 5A-5E, FIG. 5A is a voltage-to-time diagram of an input video signal. The maximum voltage of the video signal is V51. When the voltage is 0 volt, the display unit is black. With the increasing of the absolute value of the voltage, the display unit presents a grayscale gradually close to white. FIG. 5B is a voltage-to-time diagram of the video signal output by the signal output/input terminal B1 via the amplifier module 401. At this time, the video signal is amplified inversely to the voltage V52. Herein, the grayscale may be extended clearly with a higher voltage, i.e., the so-called gamma curve compensation. FIG. 5C is a voltage-to-time diagram of the video signal before compensated by the signal corrector 402. The uncompensated video signal 501 is compared with the voltages VA, VB, and VC through the signal corrector 402, so as to divide the voltage-changing process into four parts. When the voltage of the video signal is 0 volt, the 0 volt is larger than VA volt, and at the same time, larger than VB volt, and VC volt. Thus, the transistors E4-E6 are ON, and the signal corrector generates a gain value of (R42//R43//R46//R47)/R41. As a result, when the voltage of the video signal falls within the range of 0 volt-VA volts, the video signal is compensated along the compensation straight line 502.

When the voltage of the video signal is smaller than VA volts, the transistor E4 is OFF, and the transistors E5 and E6 are ON. At this time, the gain value is (R42//R46//R47)/R41. Therefore, when the voltage of the video signal falls within the range of VA volts-VB volts, the video signal is compensated along the compensation straight line 503. When the voltage of the video signal is smaller than VB volts, the transistors E4 and E5 are OFF and the transistor E6 is ON. At this time, the gain value is (R42//R47)/R41. Therefore, when the voltage of the video signal falls within the range of VB volts-VC volts, the video signal is compensated along the compensation straight line 504. When the video signal is smaller than VC volts, all of the transistors E4-E6 are OFF. At this time, the gain value is R42/R41, the video signal is compensated to the final voltage V53 volts along the compensation straight line 505.

FIG. 5D is a voltage-to-time diagram of the video signal after compensated by the signal corrector 402. When the voltage of the video signal falls within the ranges of 0 volt-VA volts, VA volts-VB volts, and VB volts-VC volts, the slopes of the compensated video are slightly different due to different startup transistors. In view of this, it can be known that different gain values can be derived by the video signal through the transistors E4, E5, and E6. The video can be compensated in multiple stages through utilizing different gain values. Then, the number of transistors and resistors can be added to increase the allowed number of divided parts, such that the compensation of the video signal is approximate to a curve. Meanwhile, the voltages VA, VB, and VC can be set as desired to increase the division levels, so as to more finely divide specific voltage ranges. Hereby, the signal corrector 402 generates different gain values to compensate the gamma curve by employing the combination of the resistors with the transistors. Not only does the circuit become less complicated, but also different gammas can be output by adjusting the numbers of the transistors and resistors and the control voltages of the transistors, and the compensation gain for any two voltages may be adjusted as desired depending on requirements to change the corresponding grayscale effect, thereby improving display quality.

FIG. 5E is a voltage-to-time diagram of the compensated video signal output through the attenuating unit 403 and the follower impedance matching element 404. The attenuating unit 403 attenuates the compensated video signal to V54, and the follower impedance matching element 404 impedance matches the video signal, so as to output a compensated video signal.

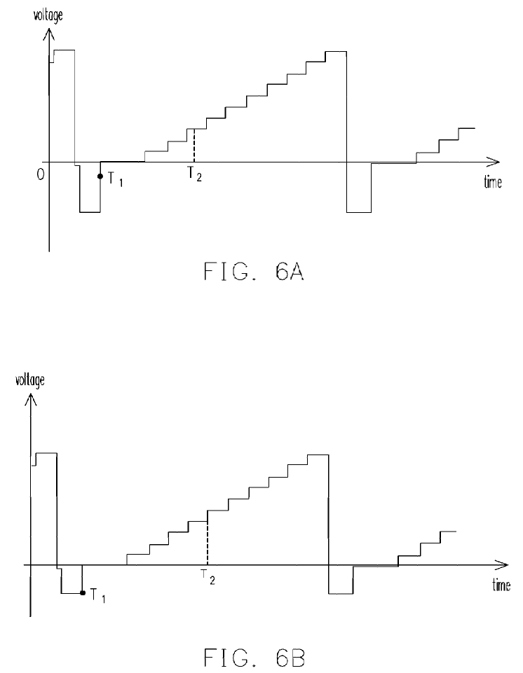

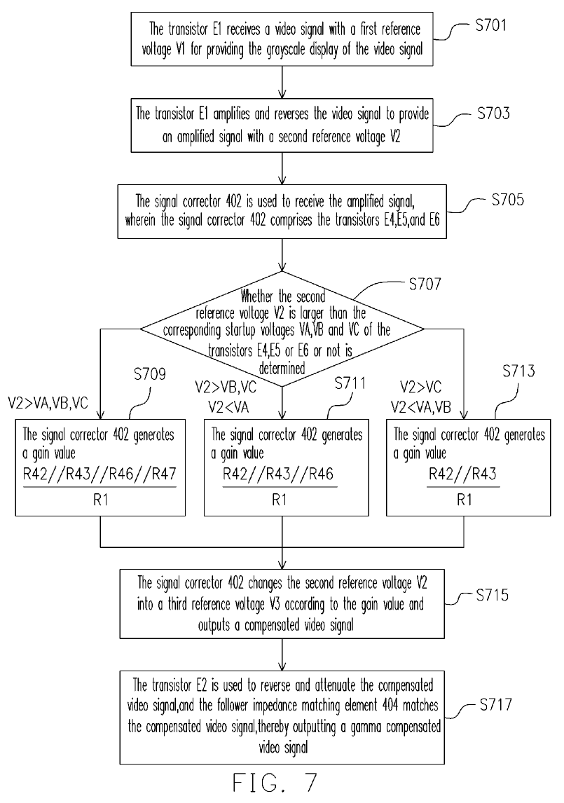

FIG. 6A is a voltage-to-time measuring diagram of the video signal before compensated by the gamma curve compensating device according to one embodiment of the present invention. FIG. 6B is a voltage-to-time measuring diagram of the video signal after compensated by the gamma curve compensating device according to one embodiment of the present invention. Referring to FIGS. 6A and 6B, from time T1 to time T2, the voltage of the video signal in FIG. 6A rapidly rises in proportion, whereas the voltage of the video signal in FIG. 6B rises slowly and tends to rise along a curve, which indicates that the gamma curve compensating device in one embodiment of the present invention can be used to compensate video signals, thereby improving display quality.

FIG. 7 is a flow chart of a gamma curve compensating method according to one embodiment of the present invention. Referring to FIGS. 4 and 7, in Step S701, the first impedance element 411 is configured to be electrically coupled to the second impedance element 412 through the amplifier module 401, and the signal corrector 402 with the impedance elements 413, 416, and 417 and the transistors E4, E5, and E6 are configured, wherein one end of each of the impedance elements 413, 416, and 417 is coupled to the amplifier module 401 and the second impedance element 412. The amplifier module 401 is implemented by the transistor E1, which is used to receive the video signal. The video signal has a first reference voltage to provide the grayscale display of the video signal. Next, in Step S703, the transistor E1 amplifies and reverses the video signal, so as to provide an amplified signal with a second reference voltage V2. Then, in Step S705, the signal corrector 402 is used to receive the reversed amplified signal, wherein the signal corrector comprises transistors E4, E5, and E6 with the startup voltages of VA, VB, and VC, respectively.

Next, in Step S707, whether the second reference voltage V2 is larger than the corresponding startup voltages VA, VB, and VC of the transistors E4, E5, and E6 or not is determined. When the second reference V2 is larger than the corresponding startup voltages VA, VB, and VC of the transistors E4, E5, and E6, the process goes to Step S709, wherein the impedance of the impedance elements 413, 416, 417 and the second impedance element 412 connected in parallel is compared with that of the first impedance element 411 to generate a gain value, i.e., an impedance ratio (R42//R43//R46//R47)/R41. When the second reference V2 is smaller than the voltage VA but larger than the voltages VB and VC, the process goes to Step S711, wherein the impedance of the impedance elements 416, 417 and the second impedance element 412 connected in parallel is compared with that of the first impedance element 411 to generate a gain value, i.e., an impedance ratio (R42//R46//R47)/R41. When the second reference voltage V2 is smaller than the voltages VA and VB, but larger than the voltage VC, the process goes to Step S713, wherein the impedance of the impedance element 417 and the second impedance element 412 connected in parallel is compared with that of the first impedance element 41 to generate a gain value, i.e., an impedance element (R42//R47)/R41. Therefore, in Step S715, the signal corrector 402 changes the second reference voltage V2 into a third reference voltage V3 according to the gain value and outputs a gamma compensated video signal. Next, in Step S717, the transistor E2 is used to inverse and attenuate the compensated video signal and impedance matches the compensated video signal through the follower impedance matching element 404, thereby outputting the gamma compensated video signal.

In summary, the present invention combines resistors with transistors in the signal corrector to generate different gain values to compensate the gamma curve structure, which has the advantages of lower circuit complexity and the ability to obtain different output gammas through adjustment. Accordingly, gamma curve compensation for a video signal can be performed, and the corresponding grayscale effects can be modified so as to improve display quality.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A gamma curve compensating device, comprising:
a first impedance element;
a second impedance element;
an amplifier module with a first end coupled to the first impedance element and a second end coupled to the second impedance element, wherein the amplifier module receives a video signal and amplifies the video signal to provide an amplified signal via the second end;
a signal corrector with a third impedance element and a first transistor, wherein a first end of the third impedance element is coupled to the second end of the amplifier module; a second end of the third impedance element is connected with the first transistor in series;
and when the voltage difference between the voltage of the second end of the amplifier module and that of the control terminal of the first transistor is larger than a startup voltage of the first transistor, the signal corrector is used to receive the amplified signal to change the signal at the second end to generate a compensated video signal; and
an attenuating unit connected with the second end for receiving the signal at the second end and attenuating the signal at the second end to output a gamma compensated video signal.

2. The gamma curve compensating device as claimed in claim 1, wherein the amplifier module comprises:
a transistor with a control terminal and two signal input/output terminals, wherein the control terminal is used to receive the video signal.

3. The gamma curve compensating device as claimed in claim 2, wherein one end of the second impedance element is electrically coupled to a predetermined voltage, and the other end is electrically coupled to one signal input/output terminal of the transistor to output the amplified signal.

4. The gamma curve compensating device as claimed in claim 3, wherein one end of the first impedance element is electrically coupled to a ground voltage, and the other end is electrically coupled to the other signal input/output terminal of the transistor.

5. The gamma curve compensating device as claimed in claim 1, wherein each of the first and second impedance elements respectively comprises a resistor.

6. The gamma curve compensating device as claimed in claim 1, wherein the attenuating unit comprises:
a transistor with a control terminal and two signal input/output terminals, wherein the control terminal is used to receive the compensated video signal;
a fourth impedance element with one end electrically coupled to a predetermined voltage and the other end electrically coupled to one signal input/output terminal of the transistor; and
a fifth impedance element with one end electrically coupled to a ground voltage and the other end electrically coupled to the other signal input/output terminal of the transistor to output the gamma compensated video signal.

7. The gamma curve compensating device as claimed in claim 6, wherein each of the fourth and fifth impedance elements comprises a resistor.

8. The gamma curve compensating device as claimed in claim 1 further comprising a follower impedance matching element, wherein one end of the follower impedance matching element receives the gamma compensated video signal and the other end is electrically coupled to a predetermined voltage.

9. A gamma curve compensating method, comprising:
configuring a first impedance element to be electrically coupled to a second impedance element through an amplifier module;
configuring a signal corrector with a third impedance element and a first transistor, wherein one end of the third impedance element is coupled to the amplifier module and the second impedance element;
enabling the amplifier module to receive a video signal and to amplify the video signal, thereby generating an amplified signal;
enabling the signal corrector to receive the amplified signal; and
when the voltage difference between the voltage of the amplified signal and that of the control terminal of the first transistor is larger than a startup voltage of the first transistor, enabling the signal corrector to receive the amplified signal and to correct the amplified signal so as to generate a compensated video signal according to an impedance ratio obtained by comparing the impedance of the third impedance element and the second impedance element connected in parallel with that of the first impedance element.

10. The gamma curve compensating method as claimed in claim 9 further comprising:
configuring an attenuating unit to be coupled to the coupling point between the third impedance element and the amplifier module, wherein the attenuating unit attenuates the signal at the coupling point between the third impedance element and the amplifier module, thereby outputting a gamma compensated video signal.
